(19) United States
(12) Patent Application Publication
(10) Pub. No.: US 2004/0143670 A1
(43) Pub. Date: Jul. 22, 2004

(54) System, method and computer program product to avoid server overload by controlling HTTP denial of service (DOS) attacks

(76) Inventors: Pratik Roychowdhury, Mountain View, CA (US); Kailash Kailash, San Jose, CA (US)

Correspondence Address: STERNE, KESSLER, GOLDSTEIN & FOX PLLC, 1100 NEW YORK AVENUE, N.W., WASHINGTON, DC, 20005, US

(21) Appl. No.: 10/610,645

(22) Filed: Jul. 2, 2003

Related U.S. Application Data
(60) Provisional application No. 60/392,931, filed on Jul. 2, 2002.

(51) Int. Cl. G06F 15/16

(52) U.S. Cl. 709/229

(57) ABSTRACT

A system, method and computer program product is presented for controlling a denial of service attack on one or more servers. The method involves intercepting, via an interface unit, a client request for information from the server; determining, by the interface unit, whether the client request is a valid request via a challenge-response mechanism; and forwarding the client request to the server if the client request is a valid request. The client request may be a HTTP request. The challenge-response mechanism involves forwarding an executable response to the client; and receiving the client request with some additional verifiable information if the client request is a valid request.

### CROSS-REFERENCE TO RELATED APPLICATIONS

The present invention claims priority to pending provisional application Ser. No. 60/392,931, filed Jul. 2, 2002, entitled “System, Method and Computer Program Product to Avoid Server Overload by Controlling HTTP Denial of Service (DOS) Attacks,” incorporated herein by reference in its entirety.

The present application is related to pending application Ser. No. 09/912,401, filed Jul. 26, 2001, entitled “System, Method and Computer Program Product to Maximize Server Throughput While Avoiding Server Overload by Controlling the Rate of Establishing Server Side Network Connections,” incorporated herein by reference in its entirety.

The present application is also related to application Ser. No. 09/188,709, filed Nov. 10, 1998, titled “Internet Client-Server Multiplexer,” now U.S. Pat. No. 6,411,986, incorporated herein by reference in its entirety.

The present application is related to pending application Ser. No. 09/690,437, filed Oct. 18, 2000, titled “Apparatus, Method and Computer Program Product for Efficiently Pooling Connections Between Clients and Servers,” incorporated herein by reference in its entirety.

### BACKGROUND OF THE INVENTION

1. Field of the Invention

The present invention relates generally to Internet client-server applications, and more specifically to a way of avoiding server overload by controlling denial of service (DoS) attacks on the server itself.

2. Background Art

One method of accessing information on the Internet is known as the World Wide Web (www, or the “web”). The web is a distributed, hypermedia system and functions as a client-server based information presentation system. Information that is intended to be accessible over the web is stored in the form of “pages” on general-purpose computers known as “servers.” Computer users can access a web page using general-purpose computers, referred to as “clients,” by specifying the uniform resource locator (URL) of the page. The web page may be implemented in HTML, or in any other implementation well known in the relevant art(s). Via the URL, the network address of the requested server is determined and the client request for connection is passed to the requested server. FIG. 1 is a network block diagram showing a plurality of clients and servers connected to the Internet.

Most servers incorporate multitasking, which consumes server resources and therefore may increase server response time. Multitasking, which is well known in the relevant art(s), is the ability to execute more than one task at the same time. Examples of a task include processing a URL or page request in order to service an existing client, establishing a new connection in order to accept new clients, closing a connection to an existing client, etc. In multitasking, one or more processors are switched between multiple tasks so that all tasks appear to progress at the same time. There are at least two basic types of multitasking that are well known to those skilled in the art, including preemptive and cooperative.

Whether the operating system of a particular server (including, but not limited to, application servers and database queuing) uses preemptive or cooperative multitasking, the response time to URL (page) requests increases as there are more tasks in the system, including tasks in the form of URL requests from more clients. In addition, the response time to a page request increases as the number of new clients trying to gain access to the server increases within a short period of time. For example, if a surge of new clients attempt to gain access to the server at the same time, then under certain load conditions the server may spend the majority of its processing resources accepting new clients rather than servicing its existing clients. A surge of new clients can be the result of a popular web site attracting many new visitors, a server attack, and so forth.

A server attack happens when one or more malicious users make regular requests that are issued at a very high rate in the attempt to crash a server. One type of server attack includes denial of service attacks. Denial of service attacks are of many types and occur at various levels. For example, many denial of service attacks are at the network level, others occur at the application level.

Denial of service attacks that occur at the application level may consist of a HTTP denial of service attack. Here, the attacker co-opts many unsuspecting computer systems to serve as “zombies” or “robots” at the direction of the attacker. In order to accomplish this, the attacker may insert in each robot a piece of software that makes the robot perform certain tasks at the command of the attacker. Such tasks include issuing HTTP Get requests simultaneously and/or repeatedly at the server that is the target of the attack. Since each robot issues requests at a higher rate than a real or human user, and since many robots act simultaneously, the servers which are attacked become overloaded. As a result of this overload, the servers are unable to serve legitimate users which results in a denial of service to these users by either dropping or blocking the user's request. Additionally, the server under attack may even crash or otherwise malfunction.

### BRIEF SUMMARY OF THE INVENTION

A system, method and computer program product is presented for controlling a denial of service attack on one or more servers. The method involves intercepting, via an interface unit, a client request for information from the server; determining, by the interface unit, whether the client request is a valid request via a challenge-response mechanism; and forwarding the client request to the server if the client request is a valid request. The client request may be a HTTP request. The challenge-response mechanism involves forwarding an executable response to the client and receiving the client request with some additional verifiable information if the client request is a valid request.

In an embodiment of the present invention, the interface unit determines whether there exists a potential denial of service attack by determining the rate at which one or more requests are to be delivered to the server and by determining whether the rate exceeds a threshold rate. In another embodiment of the present invention, the interface unit determines whether there exists a potential denial of service attack by determining the size of a queue storing one or more requests that are to be delivered to the server and by determining whether the size of the queue exceeds a preconfigured threshold.

In an embodiment of the present invention, the interface unit determines whether the client request is a valid request via a challenge-response mechanism by forwarding an executable response to the client and by receiving the client request with some additional verifiable information if the client request is a valid request. The executable response may be time bound requiring the client to execute the response within a predetermined amount of time.

In an embodiment of the invention, the executable response is cookie generation code and the additional verifiable information includes confirmation that the client correctly executed the cookie generation code. In yet another embodiment, the executable response is a JavaScript containing cookie generation code and the additional verifiable information includes confirmation that the JavaScript correctly executed the cookie generation code. In a further embodiment of the invention, the executable response is a user interaction and the additional verifiable information includes confirmation that the user correctly executed the interaction. In yet a further embodiment, the executable response is a complex algorithm and the additional verifiable information includes confirmation that the client correctly executed the complex algorithm. In another embodiment of the invention, the executable response is a requirement that the client wait a predetermined period of time to respond to the challenge and the additional verifiable information includes confirmation that the client waited the predetermined period of time prior to responding to the challenge.

### BRIEF DESCRIPTION OF THE DRAWINGS/FIGURES

The features and advantages of the present invention will become more apparent from the detailed description set forth below when taken in conjunction with the drawings in which like reference characters identify corresponding elements throughout and wherein:

FIG. 1 is a network block diagram showing a plurality of clients and servers connected to the Internet;

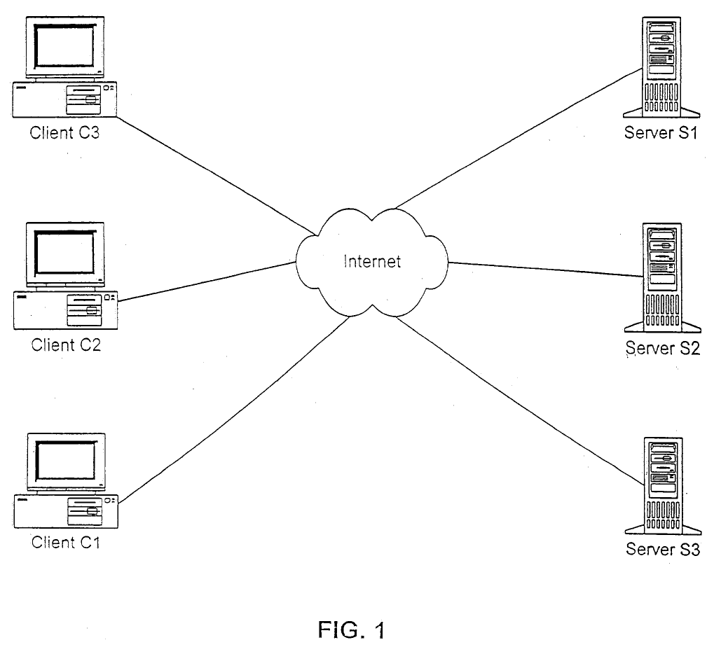

FIG. 2 is a network context diagram for an interface unit according to an embodiment of the present invention;

FIG. 3 is a flowchart illustrating the high level operation of the present invention according to an embodiment;

FIG. 4 is a flowchart illustrating the challenge-response mechanism of the present invention according to an embodiment; and

FIG. 5 depicts an example computer system in which the present invention can be implemented.

### DETAILED DESCRIPTION OF THE INVENTION

As described above, one type of server attack includes denial of service attacks. Denial of service attacks are of many types and occur at various levels, including at the network level and at the application level. Traditional network level defenses help to control denial of service attacks at the network level when the remote client has a spoofed address (not a real IP address). Traditional network level defenses cannot control denial of service attacks at the application level because, as explained above, robots have a real IP address and create valid TCP connections. The present invention is a system, method and computer program product for avoiding server overload by controlling denial of service attacks at the application level via a challenge-response mechanism.

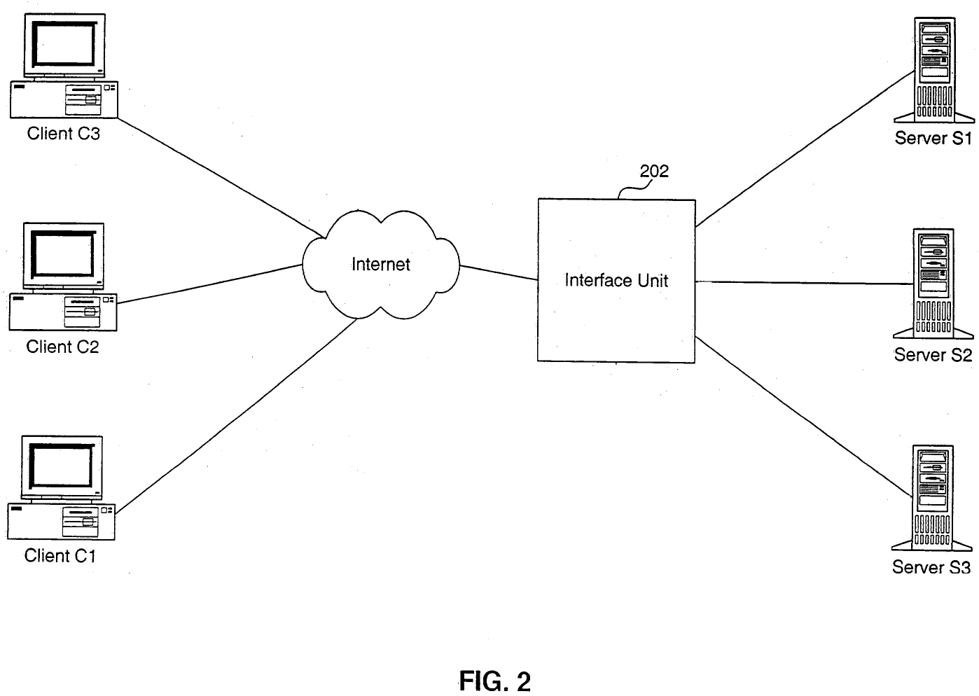

FIG. 2 is a network context diagram for an interface unit 202, which incorporates the challenge-response mechanism, according to an embodiment of the present invention. In an embodiment, interface unit 202 is an intelligent network interface card with a CPU inside a server. Interface unit 202 can also be an intelligent box sitting outside the server, in which case it can serve more than one server. Interface unit 202 can also be a load balancer, bandwidth manager, firewall, proxy-cache, router, switch, computer system, or any other network device that is located between a client and server.

Referring to FIG. 2, a plurality of clients C1, C2, C3 are coupled to the Internet. A plurality of servers S1, S2, S3 are coupled to the Internet by interface unit 202. Servers S1, S2, S3 are collectively referred to as a “server farm.” In an embodiment of the present invention, all Internet traffic with the server farm passes through interface unit 202. While the present invention is described in terms of the Internet, the concepts described also apply to other types of networks, as will be apparent to one skilled in the relevant art.

In an embodiment of the present invention, interface unit 202 relieves servers S1, S2, S3 of much of the processing load caused by repeatedly opening and closing connections to clients by opening one or more connections with each server and maintaining these connections to allow repeated data accesses by clients via the Internet. This technique is referred to herein as “connection pooling.” Interface unit 202 also transparently splices connections from servers and clients using a technique referred to herein as “connection multiplexing.” In an embodiment of the present invention, multiplexed connections are used and reused to regulate the flow of HTTP requests to a server or server farm rather than blocking or dropping new requests once maximum server capacity is reached. The techniques of “connection pooling” and “connection multiplexing” are described in detail in related U.S. Pat. No. 6,411,986 and application Ser. No. 09/690,437.

In the present invention, interface unit 202 avoids server overload due to a HTTP denial of service attack by regulating the rate (and the increase in the rate) at which HTTP requests sent by remote clients are to be delivered to a server or set of servers, and if a configured threshold rate is exceeded (which indicates the possibility of a denial of service attack on the server or set of servers), then triggering a challenge-response mechanism. In another embodiment of the present invention, the HTTP requests sent by the remote clients are queued up inside interface unit 202. When the size of the queue exceeds a preconfigured threshold (which indicates the possibility of a denial of service attack on the server or set of servers), then the challenge-response mechanism is triggered. The present invention is related to U.S. patent application Ser. No. 09/912,401, where a method for maximizing server throughput while avoiding overload of a server is presented. The method involves intercepting, via interface unit 202, a client request for information from the server. Next, interface unit 202 determines the current server performance, where the server performance is based on the number of connections opened to the server, the response time of the server and the rate at which the response time is changing. Finally, interface unit 202 forwards the client request to the server if the current server performance is close to an optimal performance, whereby avoiding overload of the server.

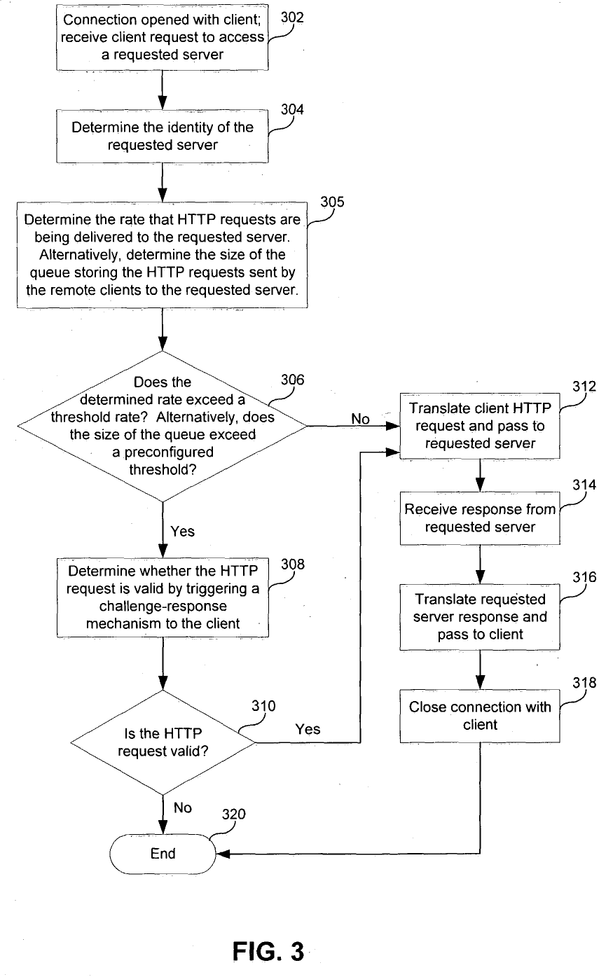

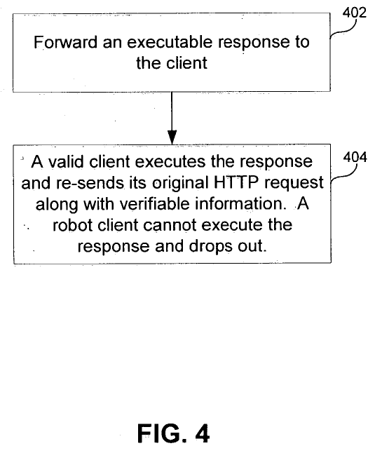

The challenge-response mechanism of the present invention verifies the validity of HTTP requests from one or more remote clients. A remote client that issues valid HTTP requests is known herein as a “valid client.” Valid HTTP requests are delivered to the requested server. Invalid HTTP requests are not. A remote client that issues invalid HTTP requests is known herein as a “robot client.” FIGS. 3 and 4 below describe the challenge-response mechanism of the present invention in more detail.

FIG. 3 is a high level flowchart illustrating how the present invention implements the challenge-response mechanism. The process in FIG. 3 begins when a client requests access via a HTTP request to one of the servers in the server farm (herein referred to as the “requested server”) tended by interface unit 202. A connection is opened between interface unit 202 and the requesting client, and interface unit 202 receives the client request to access the requested server, as shown in step 302.

Next, interface unit 202 determines the identity of the requested server as shown in step 304. In one embodiment, this is accomplished by examining the destination network address specified by the client request. In another embodiment, this is accomplished by examining the network address and path name specified by the client request.

Interface unit 202 then determines the rate that HTTP requests are currently being delivered to the requested server in step 305. As described above in another embodiment of the invention, interface unit 202 in step 305 determines the size of the queue storing the HTTP requests sent by the remote clients to the requested server.

In step 306, if the determined rate exceeds a threshold rate (or if the size of the queue exceeds the preconfigured threshold in the alternate embodiment), then control passes to step 308. Once the threshold rate is exceeded (or the size of the queue exceeds the preconfigured threshold in the alternate embodiment), this is an indication that the server may be under a denial of service attack. Alternatively, control passes to step 312.

In step 308, interface unit 202 determines whether the HTTP request is valid by triggering a challenge-response mechanism to the client. FIG. 4 below describes the challenge-response mechanism in more detail.

Next, in step 310, interface unit 202 determines whether the HTTP request came from a valid client or a robot client. The present invention delivers valid HTTP requests to the requested server, and alternatively, does' not deliver invalid HTTP requests to the server. If the HTTP request is valid, then control passes to step 312 (to forward the HTTP request to the requested server). Otherwise, control passes to 320 where the flowchart in FIG. 3 ends (and the invalid HTTP request never gets forwarded to the requested server).

In step 312, interface unit 202 then translates the client request and passes it to the requested server.

After server processing, interface unit 202 receives a response from the requested server, as shown in step 314.

The server response is translated and passed to the requesting client, as shown in step 316.

Finally, interface unit 202 closes the connection with the client as shown in step 318, and the flowchart in FIG. 3 ends. However, by utilizing the “connection pooling” and “connection multiplexing” techniques referenced above, the connection between interface unit 202 and the requested server is not disconnected. However, the present invention may close down the connection if it determines that the server is currently overloaded (i.e., current load is greater than the optimal load). The details of how steps 312-318 are implemented are more fully described in related application Ser. No. 09/912,401.

FIG. 4 is a flowchart describing in more detail the challenge-response mechanism of the present invention. In step 402, interface unit 202 forwards an executable response to the client. In an embodiment of the invention, the executable response is a JavaScript containing cookie generation code. In alternative embodiments of the invention, the executable response may include one or more of the following (or some combination thereof): user interaction, the client (browser) may be required to execute a complex algorithm, and the client (browser) may be required to wait a certain period of time to respond to the challenge. Control then passes to step 404.

In step 404, a valid client executes the executable response and then re-sends its original HTTP request along with verifiable information. In the embodiment where the executable response is a JavaScript containing cookie generation code, the JavaScript forces the client to send back the request along with the cookie, which is calculated only from the JavaScript. In the alternative embodiments described above (e.g., user interaction, the client (browser) may be required to execute a complex algorithm, the client (browser) may be required to wait a certain period of time to respond to the challenge, etc.), user interface 202 also waits for the client to send back the request along with the proof of the required executable response(s) to prove that the client (browser) initiating the request is a valid (or legitimate) client and thus the request is valid (or legitimate). In the present invention, any of the executable responses may be time bound requiring the client to execute the response within a predetermined amount of time.

This request sent back by the client in step 404 is forwarded to the server upon validating that the executable response received by interface unit 202 was executed correctly (which indicates a valid client). Robot clients drop the response upon receipt and thereby fail to complete the challenge-response (and thus prevent their requests from being forwarded to the server). When invalid requests are dropped, the denial of service attack on the server is controlled by the present invention. The flowchart in FIG. 4 ends at this point.

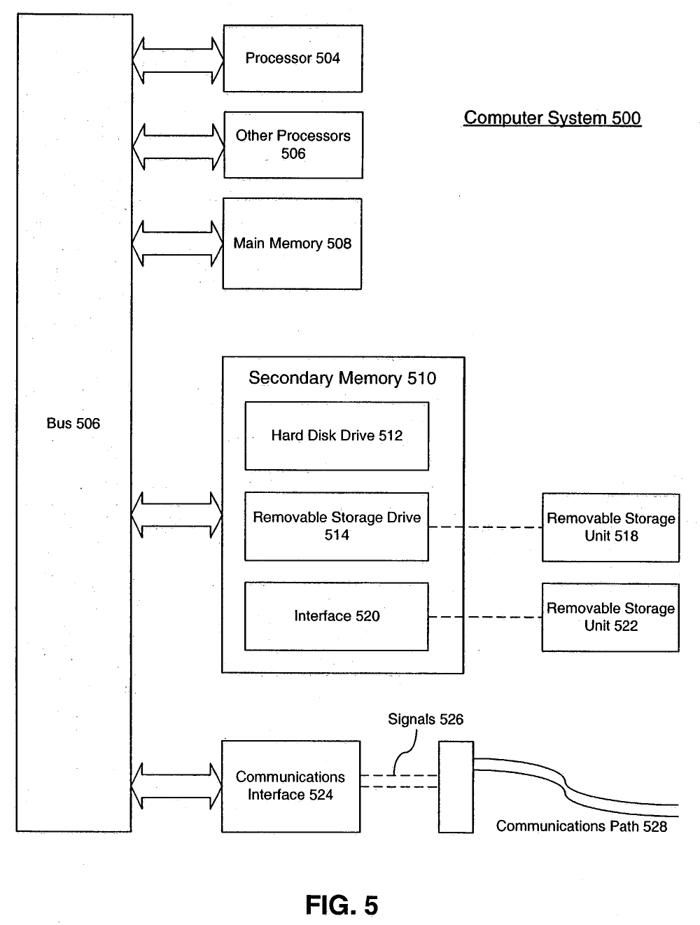

The present invention may be implemented using hardware, software or a combination thereof and may be implemented in a computer system or other processing system. In fact, in one embodiment, the invention is directed toward one or more computer systems capable of carrying out the functionality described herein. An example computer system 500 is shown in FIG. 5. The computer system 500 includes one or more processors, such as processor 504. The processor 504 is connected to a communication bus 506. Various software embodiments are described in terms of this example computer system. After reading this description, it will become apparent to a person skilled in the relevant art how to implement the invention using other computer systems and/or computer architectures.

Computer system 500 also includes a main memory 508, preferably random access memory (RAM) and can also include a secondary memory 510. The secondary memory 1010 can include, for example, a hard disk drive 512 and/or a removable storage drive 514, representing a floppy disk drive, a magnetic tape drive, an optical disk drive, etc. The removable storage drive 514 reads from and/or writes to a removable storage unit 518 in a well known manner. Removable storage unit 518, represents a floppy disk, magnetic tape, optical disk, etc. which is read by and written to by removable storage drive 514. As will be appreciated, the removable storage unit 518 includes a computer usable storage medium having stored therein computer software and/or data.

In alternative embodiments, secondary memory 510 may include other similar means for allowing computer programs or other instructions to be loaded into computer system 500. Such means can include, for example, a removable storage unit 522 and an interface 520. Examples of such can include a program cartridge and cartridge interface (such as that found in video game devices), a removable memory chip (such as an EPROM, or PROM) and associated socket, and other removable storage units 522 and interfaces 520 which allow software and data to be transferred from the removable storage unit 518 to computer system 500.

Computer system 500 can also include a communications interface 524. Communications interface 524 allows software and data to be transferred between computer system 500 and external devices. Examples of communications interface 524 can include a modem, a network interface (such as an Ethernet card), a communications port, a PCMCIA slot and card, etc. Software and data transferred via communications interface 524 are in the form of signals which can be electronic, electromagnetic, optical or other signals capable of being received by communications interface 524. These signals 526 are provided to communications interface via a channel 528. This channel 528 carries signals 526 and can be implemented using wire or cable, fiber optics, a phone line, a cellular phone link, an RF link and other communications channels.

In this document, the terms “computer program medium” and “computer usable medium” are used to generally refer to media such as removable storage device 518, a hard disk installed in hard disk drive 512 and signals 526. These computer program products are means for providing software to computer system 500.

Computer programs (also called computer control logic) are stored in main memory 508 and/or secondary memory 510. Computer programs can also be received via communications interface 524. Such computer programs, when executed, enable the computer system 500 to perform the features of the present invention as discussed herein. In particular, the computer programs, when executed, enable the processor 504 to perform the features of the present invention. Accordingly, such computer programs represent controllers of the computer system 500.

In an embodiment where the invention is implemented using software, the software may be stored in a computer program product and loaded into computer system 500 using removable storage drive 514, hard drive 512 or communications interface 524. The control logic (software), when executed by the processor 504, causes the processor 504 to perform the functions of the invention as described herein.

In another embodiment, the invention is implemented primarily in hardware using, for example, hardware components such as application specific integrated circuits (ASICs). Implementation of the hardware state machine so as to perform the functions described herein will be apparent to persons skilled in the relevant art(s). In yet another embodiment, the invention is implemented using a combination of both hardware and software.

The present invention is described specifically when implemented within an interface unit, such as interface unit 202, that is connected to servers in a farm for the purpose of offloading connection processing overhead from the servers. However, the present invention can also be applied within other kinds of devices that are in the network connection path between the client and the servers. As network traffic flows through such devices, they all have the opportunity to apply the present invention to offload connection processing. Some examples of such devices are:

Load Balancers which distribute client network connections between a set of servers in a server farm (local or geographically distributed). The invention can readily be combined with the load balancing function.

Bandwidth managers which monitor network traffic and meter packet flow. These devices can also use the present invention.

Firewalls monitor packets and allow only the authorized packets to flow through. The present invention can be used to provide an additional feature within firewalls.

The industry trend is to integrate additional functionality (such as load balancing, bandwidth management and firewall functionality) within these devices. Hence, the present invention can easily be incorporated into a multi-function device that may include routing.

The specific integration of the present invention into each one of the above devices is implementation specific.

The present invention can also be applied within computer systems which are the end points of network connections. In this case, add-on cards can be used to implement the invention and thus offload the main processing elements within the computer system.

### CONCLUSION

The previous description of the preferred embodiments is provided to enable any person skilled in the art to make or use the present invention. The various modifications to these embodiments will be readily apparent to those skilled in the art and the generic principles defined herein may be applied to other embodiments without the use of the inventive faculty. Thus, the present invention is not intended to be limited to the embodiments shown herein but is to be accorded the widest scope consistent with the principles and novel features disclosed herein.

What is claimed is:

1. A method for controlling a denial of service attack on a server, comprising the steps of:
intercepting, via an interface unit, a client request for information from the server;
determining whether there exists a potential denial of service attack on the server;
if the potential denial of service attack exists, then determining, by the interface unit, whether the client request is a valid request via a challenge-response mechanism; and
forwarding the client request to the server if the client request is a valid request.

2. The method of claim 1, wherein the client request is a HTTP request.

3. The method of claim 1, wherein the step of determining whether there exists a potential denial of service attack comprises the steps of:
determining the rate at which one or more requests are to be delivered to the server; and
determining whether the rate exceeds a threshold rate.

4. The method of claim 1, wherein the step of determining whether there exists a potential denial of service attack comprises the steps of:
determining the size of a queue storing one or more requests that are to be delivered to the server; and
determining whether the size of the queue exceeds a preconfigured threshold.

5. The method of claim 1, wherein the step of determining, by the interface unit, whether the client request is a valid request via a challenge-response mechanism includes the steps of:
forwarding an executable response to the client; and
receiving the client request with some additional verifiable information if the client request is a valid request.

6. The method of claim 5, wherein the executable response is time bound requiring the client to execute the response within a predetermined amount of time.

7. The method of claim 5; wherein the executable response is cookie generation code and wherein the additional verifiable information includes confirmation that the client correctly executed the cookie generation code.

8. The method of claim 5, wherein the executable response is a JavaScript containing cookie generation code and wherein the additional verifiable information includes confirmation that the JavaScript correctly executed the cookie generation code.

9. The method of claim 5, wherein the executable response is a user interaction and wherein the additional verifiable information includes confirmation that the user correctly executed the interaction.

10. The method of claim 5, wherein the executable response is a complex algorithm and wherein the additional verifiable information includes confirmation that the client correctly executed the complex algorithrn.

11. The method of claim 5, where the executable response is a requirement that the client wait a predetermined period of time to respond to the challenge and wherein the additional verifiable information includes confirmation that the client waited the predetermined period of time prior to responding to the challenge.

12. A system for controlling a denial of service attack on a server, comprising:
a interface unit,
wherein the interface unit intercepts a client request for information from the server,
wherein the interface unit determines whether there exists a potential denial of service attack on the server,
wherein the interface unit determines whether the client request is a valid request via a challenge-response mechanism if the potential denial of service attack exists, and
wherein the interface unit forwards the client request to the server if the client request is a valid request.

13. The system of claim 12, wherein the client request is a HTTP request.

14. The system of claim 12, wherein the interface unit determines whether there exists a potential denial of service attack by determining the rate at which one or more requests are to be delivered to the server and by determining whether the rate exceeds a threshold rate.

15. The system of claim 12, wherein the interface unit determines whether there exists a potential denial of service attack by determining the size of a queue storing one or more requests that are to be delivered to the server and by determining whether the size of the queue exceeds a preconfigured threshold.

16. The system of claim 12, wherein the interface unit determines whether the client request is a valid request via a challenge-response mechanism by forwarding an executable response to the client and by receiving the client request with some additional verifiable information if the client request is a valid request.

17. The system of claim 16, wherein the executable response is time bound requiring the client to execute the response within a predetermined amount of time.

18. The system of claim 16, wherein the executable response is cookie generation code and wherein the additional verifiable information includes confirmation that the client correctly executed the cookie generation code.

19. The system of claim 16, wherein the executable response is a JavaScript containing cookie generation code and wherein the additional verifiable information includes confirmation that the JavaScript correctly executed the cookie generation code.

20. The system of claim 16, wherein the executable response is a user interaction and wherein the additional verifiable information includes confirmation that the user correctly executed the interaction.

21. The system of claim 16, wherein the executable response is a complex algorithm and wherein the additional verifiable information includes confirmation that the client correctly executed the complex algorithm.

22. The system of claim 16, where the executable response is a requirement that the client wait a predetermined period of time to respond to the challenge and wherein the additional verifiable information includes confirmation that the client waited the predetermined period of time prior to responding to the challenge.

23. A method for controlling a denial of service attack on a server, comprising the steps of:
intercepting, via an interface unit, a first client request for information from the server;
determining whether there exists a potential denial of service attack on the server;
if the potential denial of service attack exists, then forwarding a first executable response to the client;
receiving the first client request with some additional verifiable information if the client request is a valid request;
forwarding the first client request to the server if the client request is a valid request;
intercepting, via the interface unit, a second client request for information from the server; and
if the potential denial of service attack still exists, then forwarding a second executable response to the client, wherein the first and second executable responses of a different types.
